(19) United States
(12) Patent Application Publication
(10) Pub. No.: US 2015/0358932 A1
(43) Pub. Date: Dec. 10, 2015

(54) DEVICE FOR SYNCHRONIZING THE BROADCASTING OF SOUND SIGNALS AND SOUND BROADCASTER

(71) Applicant: AWOX, Montpellier (FR)

(72) Inventors: Alain MOLINIE, Montpellier (FR); Eric LAVIGNE, Montpellier (FR); Vincent LECLAIRE, Montpellier (FR)

(21) Appl. No.: 14/760,209

(22) PCT Filed: Dec. 24, 2013
(86) PCT No.: PCT/FR2013/053263

§ 371 Date: Jul. 10, 2015

(30) Foreign Application Priority Data
Jan. 10, 2013 (FR) 1350230

(51) Int. Cl. H04W 56/00; H04L 29/06

(52) U.S. Cl. CPC H04W 56/005; H04L 65/608; H04L 65/80; H04L 69/16

(57) ABSTRACT

The sound-signal broadcaster utilizing the IEEE 802.11 standard including the transmission of a periodic IEEE 802.11 beacon frame signal separate from the transmitted data and representative of the period number of the beacon frame signal, includes: elements for receiving signals according to standard IEEE 802.11 representing: the beacon frame signal, and at least one packet representative of the sound signals to be broadcast into which a period number of the beacon frame signal has been incorporated, so as to broadcast the sound signal represented by each data packet at a predefined time on the basis of the period number incorporated into the packet. The broadcaster may include elements for determining a processing operation to be executed on each received packet on the basis of the difference between the period number of the received beacon frame signal and the period number of the beacon frame signal incorporated into the received packet.

### RELATED APPLICATIONS

This application is a §371 application from PCT/FR2013/053263 filed Dec. 24, 2013, which claims priority from French Patent Application No. 1350230 filed Jan. 10, 2013, each of which is herein incorporated by reference in its entirety.

### TECHNICAL FIELD OF THE INVENTION

The present invention envisages a device for synchronizing the broadcasting of sound signals and a sound broadcaster. It applies in particular to the synchronization of wireless sound transmitters in a home automation installation.

### STATE OF THE ART

For the rest of this document, the standard IEEE 802.11 will also be referred to as “Wi-Fi” (registered trademark).

In addition, “beacon frame” will refer to a computer frame signal used by standard IEEE 802.11 comprising, in addition, an 802.11 TSF timestamp. The initial purpose of this frame signal is to signal the presence of a Wi-Fi network to communicating appliances, optimizing the power consumption of appliances present in a network.

In the context of providing sound in a place using wireless loudspeakers, and in order to offer a comfortable sound environment, the wireless loudspeakers must transmit sound in a synchronized way, e.g. with an offset between them of less than two milliseconds. The difficulty in implementing such systems is to ensure the correct synchronization between the system's various appliances.

In current systems, based on Wi-Fi technology in particular, a transmitting station generates a time signal transferred to signal broadcasters connected wirelessly to this station. However, these generated clocks are difficult to utilize.

These systems do not therefore respond in a simple, optimized way to the constraint of synchronization between transmitters and wireless sound-signal broadcasters.

### SUBJECT OF THE INVENTION

The present invention aims to remedy all or part of these drawbacks.

To this end, the present invention envisages a device for synchronizing the broadcasting of sound signals, utilizing the IEEE 802.11 standard comprising the transmission of a periodic IEEE 802.11 beacon frame signal separate from the transmitted data and representative of the period number of the beacon frame signal, which comprises:
a means for incorporating a period number of the beacon frame signal into data packets representative of the sound signal to be broadcast by at least one sound-signal broadcaster; and
a means for transmitting signals according to standard IEEE 802.11 representing:
   the beacon frame signal and
   the packets representative of sound signals to be broadcast,
      in such a way that each sound-signal broadcaster can broadcast the sound signal represented by each data packet at a predefined time on the basis of the period number incorporated into said packet.

The invention consists in particular of turning the beacon frame signal from its initial purpose to make it a synchronization element between different appliances in a wireless network, making it possible to determine a sound-signal's broadcast time. In this way, in the case of transmission means and sound-signal broadcasters connected by the utilization of a Wi-Fi standard, using the beacon frame signal makes it possible to use a clock incorporated into said standard as a synchronization signal between the different appliances. In addition, the processing required for synchronizing the clocks of each appliance of the system is reduced significantly since the synchronization is incorporated into the Wi-Fi standard. Lastly, the use of the beacon frame signal makes possible a reliable and accurate synchronization between the transmission means and the sound-signal broadcasters even if the broadcasters do not have a clock. The maximum synchronization offset claimed by the beacon frame is, in addition, of the order of two milliseconds.

In certain embodiments, a period number of the beacon frame signal is incorporated into each data packet representative of the sound signal.

These embodiments have the advantage of increasing the reliability of the device by increasing the level of information available for the system. Thus, in the case of the collision of packets, for example, the device is able to order the packets chronologically by means of the 802.11 TSF function's individual timestamping of each packet.

In certain embodiments, the means for transmitting signals determines the time of the sound signal's broadcast by each sound-signal broadcaster, adding a constant value to the current period number of the beacon frame signal.

The advantage of these embodiments is that it makes it possible to take into account the propagation time of the packet containing data representative of the sound signal from the transmission means to the wireless sound broadcaster in the 802.11 TSF function's timestamping of the determined time that these data were read.

In certain embodiments, the transmission means utilizes an RTP connection transported by the UDP protocol, the session thus generated being managed by the RTSP protocol.

These embodiments have the advantage of allowing speedy transmission of data.

In certain embodiments, the transmission means utilizes an RTP connection transported by the TCP protocol, the session thus generated being managed by the HTTP protocol.

These embodiments have the advantage of allowing a significant throughput between the device and a sound broadcaster, for example, paired with the device.

The present invention also envisages a sound-signal broadcaster utilizing the IEEE 802.11 standard comprising the transmission of a periodic IEEE 802.11 beacon frame signal separate from the transmitted data and representative of the period number of the beacon frame signal, which comprises:
a means for receiving signals according to standard IEEE 802.11 representing:
   the beacon frame signal and
   at least one packet representative of the sound signals to be broadcast into which a period number of the beacon frame signal has been incorporated,
      in such a way as to broadcast the sound signal represented by each data packet at a predefined time on the basis of the period number incorporated into said packet.

Using the beacon frame signal makes it possible, in the case of wireless sound broadcasters, to use a clock incorporated into said protocols as a synchronization signal between the different appliances. In addition, the processing required for synchronizing the clocks of each appliance of the system is reduced significantly since the synchronization is incorporated into the Wi-Fi standard. Lastly, the use of the beacon frame signal makes possible a reliable and accurate synchronization between a transmission means and each sound-signal broadcaster.

In certain embodiments, the broadcaster that is the subject of the present invention comprises a means for determining a processing operation to be carried out on each received packet on the basis of the difference between the period number of the received beacon frame signal and the period number of the beacon frame signal incorporated into the received packet.

These embodiments also make it possible to adjust the processing carried out on a received packet on the basis of its earliness or lateness, when it is received by the sound broadcaster, relative to its determined reading time.

In certain embodiments, the reception means utilizes an RTP connection transported by the UDP protocol, the session thus generated being managed by the RTSP protocol.

These embodiments have the advantage of allowing speedy reception of the data.

In certain embodiments, the reception means utilizes an RTP connection transported by the TCP protocol, the session thus generated being managed by the HTTP protocol.

These embodiments have the advantage of allowing a significant bandwidth between the broadcaster and a broadcast synchronization device, for example.

The present invention also envisages a method for synchronizing the broadcasting of sound signals, utilizing the IEEE 802.11 standard comprising the transmission of a periodic IEEE 802.11 beacon frame signal separate from the transmitted data and representative of the period number of the beacon frame signal, which comprises:
a step of incorporating a period number of the beacon frame signal into data packets representative of the sound signal to be broadcast by at least one sound-signal broadcaster; and
a step of transmitting signals according to standard IEEE 802.11 representing:
   the beacon frame signal and
   the packets representative of sound signals to be broadcast; and
a step of broadcasting the sound signal, represented by each data packet, by each sound-signal broadcaster at a predefined time on the basis of the period number incorporated into said packet.

As the particular features, advantages and aims of this method are similar to those of the device for synchronizing the broadcasting of sound signals that is the subject of the present invention, they are not repeated here.

The present invention also envisages a method for broadcasting sound signals utilizing the IEEE 802.11 standard comprising the transmission of a periodic IEEE 802.11 beacon frame signal separate from the transmitted data and representative of the period number of the beacon frame signal, comprising:
a step of receiving signals according to standard IEEE 802.11 representing:
   the beacon frame signal and
   at least one packet representative of the sound signals to be broadcast into which a period number of the beacon frame signal has been incorporated,
a step of verifying the integrity of each packet received,
an iterative step of comparing the period number of the received beacon frame signal and the period number of the beacon frame signal incorporated into the received packet; and
a step of broadcasting the sound signal represented by each data packet received on the basis of the result of the comparison step.

As the particular features, advantages and aims of this method are similar to those of the sound-signal broadcaster that is the subject of the present invention, they are not repeated here.

In certain embodiments, the method that is the subject of the present invention also comprises a step of determining the time of the sound signal's broadcast by sound-signal broadcasters, adding a constant value to a period number of the beacon frame signal read in each packet received.

These embodiments have the advantage of making it possible to take into account the propagation time of the packet containing data representative of the sound signal from the transmission means to the wireless sound broadcaster in the 802.11 TSF function's timestamping of the determined time that these data were read.

In certain embodiments, the method that is the subject of the present invention comprises a step of determining a processing operation to be carried out on each received packet on the basis of the difference between the period number of the received beacon frame signal and the period number of the beacon frame signal incorporated into the received packet.

These embodiments also make it possible to adjust the processing carried out on a received packet on the basis of its earliness or lateness, when it is received by the sound broadcaster, relative to its determined reading time.

### BRIEF DESCRIPTION OF THE FIGURES

Other advantages, aims and features of the invention will become apparent from the description that follows of at least one particular embodiment of the device for synchronizing the broadcasting of sound signals, made with reference to drawings included in an appendix, wherein:

FIG. 1 shows, schematically, a first particular embodiment of the device for synchronizing the broadcasting of sound signals that is the subject of the present invention;

FIG. 2 shows, schematically, a second particular embodiment of the device for broadcasting sound signals that is the subject of the present invention;

FIG. 3 represents a logical diagram of particular steps of the method for synchronizing the broadcasting of sound signals that is the subject of the present invention; and

FIG. 4 represents a logical diagram of particular steps of the method for broadcasting sound signals that is the subject of the present invention.

### DESCRIPTION OF EXAMPLES OF REALIZATION OF THE INVENTION

The present description is given as a non-limiting example.

It is now noted that the figures are not to scale.

As will be seen in the description that follows, the invention consists in particular of turning the beacon frame signal from its initial purpose to make it a synchronization element between different appliances in a wireless network, making it possible to determine a sound-signal's broadcast time.

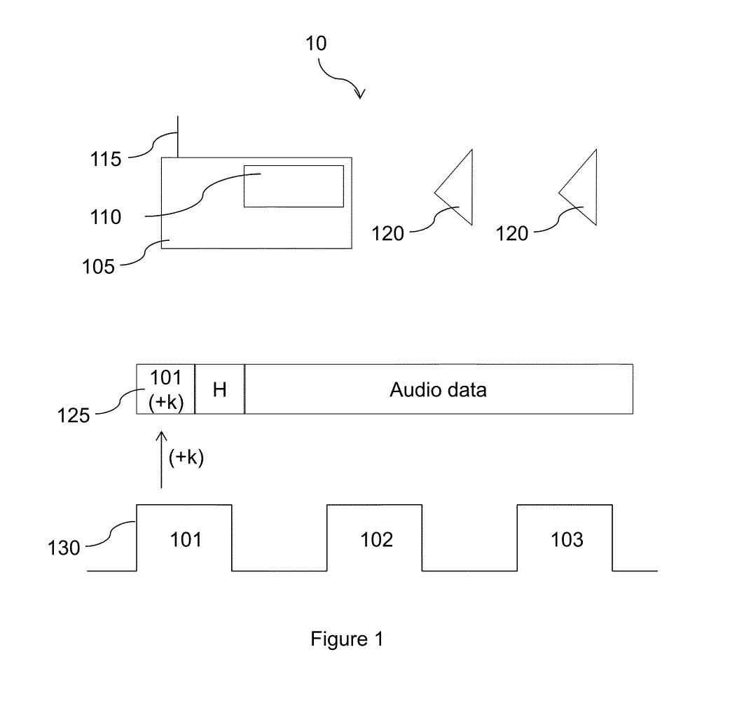

FIG. 1 shows the first particular embodiment of the device 10 that is the subject of the present invention. This device 10 comprises:
a transmitter 105 of sound signals, which comprises:
   a means 110 for incorporating a period number of the beacon frame signal 130 into packets 125,
   a means 115 for transmitting signals; and
at least two sound broadcasters 120.

This sound-signal transmitter 105 can be, for example, a portable communicating terminal connected to a Wi-Fi type of wireless internet network. Alternatively, this transmitter 105 can be a television connected by Wi-Fi and, generally, any item of equipment transmitting a sound signal configured to be configured by Wi-Fi with sound broadcasters 120.

In order to synchronize the broadcasting of sound signals transmitted by the sound-signal transmitter 105, by the two sound broadcasters 120, the sound-signal transmitter 105 comprises a means 110 for incorporating a period number of the beacon frame signal 130 into data packets 125 representative of the sound signal to be broadcast by each sound-signal broadcaster 120. This incorporation means 110 reads, in the beacon frame signal 130, the current period number such as, for example, the timestamping of the 802.11 TSF function. Then, this incorporation means 110 incorporates the current period number read in the metadata of a packet 125 containing data representative of sound signals. This current period number is for preference incorporated into a metadata element, called “time to play”, of the packet 125.

In variants, this incorporation means 110 adds an arbitrary constant offset (annotated “k” in FIG. 1), corresponding to the estimated travel time of a packet 125 from the transmitter to the farthest broadcaster, to this period number before incorporating it into each packet 125. In these variants, it is the synchronization device that thus specifies at which value of the period value indicated by the beacon frame each broadcaster must broadcast the sound signal represented by the data incorporated into the packet. Alternatively, the incorporation means 110 memorizes the first current period number read at the time of the transmission of the first sound signal to be broadcast. In these variants, the incorporation means 110 adds to the current period number initially read, in the “time to play” metadata element of the following sound signals, as well as the arbitrary constant offset, the sum of the durations of the set of sound signals transmitted in addition to the first.

In other variants, the offset is arbitrary and constant during the first initialization of the device 10. In this variant, once the first signal has been sent to the sound broadcasters 120 by the transmitter 105 of sound signals, each sound broadcaster 120 communicates to the transmitter 105 a measurement of the time required to process the sound signal received. This measurement is carried out by calculating the time difference between the time when the sound signal received by each sound broadcaster 120 is ready for broadcasting and the time when the sound signal is received. Alternatively, this difference can be calculated between the time when the sound signal is ready for broadcasting and the time when the sound signal is transmitted. During the reception of each measurement transmitted by a sound broadcaster 120, the sound-signal transmitter 105 adjusts the offset value by selecting the largest value from amongst the initial value and each received measurement of the sound broadcasters 120. This value is recorded by the transmitter 105 of sound signals and used at each subsequent starting up of the system. This offset calculation is carried out again when a new appliance is added to the device 10.

In other variants, this offset is calculated by each broadcaster that adds a constant value to the beacon frame 130 period number read in the packets 125 received. In these variants, it is the broadcasters that determines, with the same constant k added to the period number read in the packet, the period number that corresponds to the broadcasting of sound signals.

In the context of the RTSP protocol (“Real Time Streaming Protocol”), an 802.11 TSF function timestamping is carried out on each packet 125 transmitted. In variants not using the RTSP protocol, the 802.11 TSF function timestamping is not carried out on each packet 125 but in a regular way on a certain number of packets 125.

This transmitter 105 also comprises a means 115 for transmitting signals according to standard IEEE 802.11, such as for example a Wi-Fi antenna, representing:
the beacon frame signal 130 and
the packets 125 representative of sound signals to be broadcast.

To synchronize the broadcasting of sound signals, each sound broadcaster 120 extracts and broadcasts the sound signal contained in each packet 125 received when the metadata element (a period number of the beacon frame signal 130 of said packet 125), incorporated by the incorporation means 110 corresponds to the period number of the beacon frame signal 130 received. In this way, as the received beacon frame signal 130 is identical for all of the sound broadcasters, the reading of the data representative of the sound signal is synchronized between the various broadcasters.

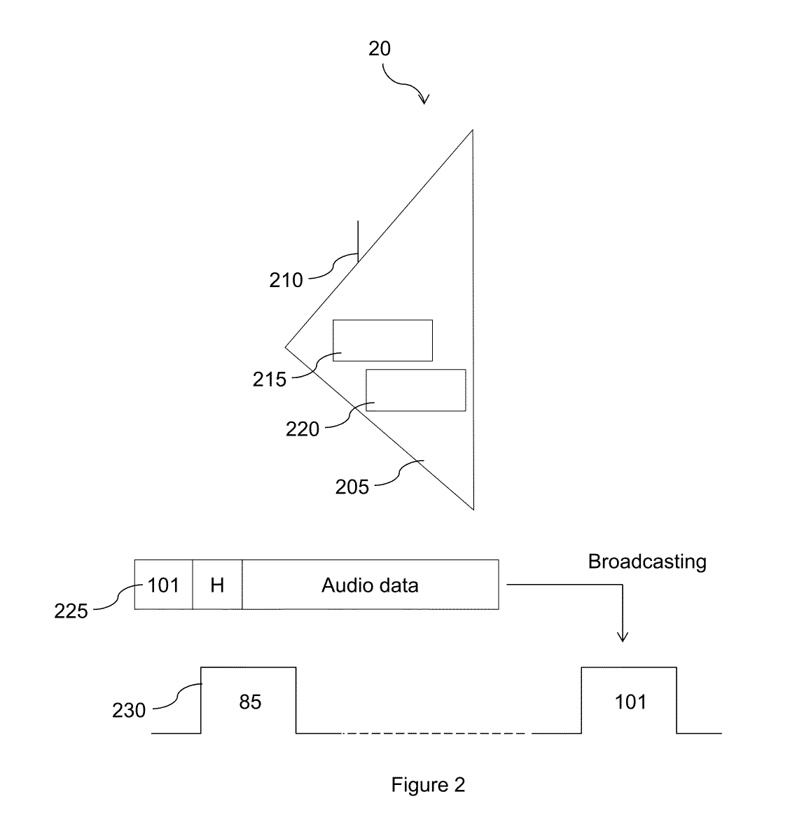

FIG. 2 shows the second embodiment of the device for broadcasting sound signals that is the subject of the present invention. This device 20 comprises:
a means 210 for receiving beacon frame signals 230 and packets 225 according to standard IEEE 802.11;
a means 215 for determining a processing operation to be carried out on each received packet 225; and
a means 220 for calculating the time of the sound signal's broadcast.

The means 210 for receiving signals, for example a Wi-Fi antenna, operating according to the standard IEEE 802.11, representing:
the beacon frame signal 230; and
at least one packet 225 representative of the sound signals to be broadcast into which a period number of the beacon frame signal 230 has been incorporated.

The processing determination means 215 determines a processing operation to be carried out on each received packet 225 on the basis of the difference between the period number of the received beacon frame signal 230 and the period number of the beacon frame signal 230 incorporated into the received packet 225. In this way, for example, if a packet 225 is received with a delay greater than a predefined limit value with respect to its broadcast time, it is ignored by the broadcaster. If its broadcast time has not yet arrived, it is put on hold. If it is in the interval, the data representative of the sound signal are broadcast immediately. The predefined limit value can correspond, for example, to the length of time to read the data representative of the sound signal contained in a packet 225, for example.

The means 220 for calculating the broadcast time of the sound signal represented by data in a packet 225 adds a constant value to the period number of the beacon frame signal 230 associated to said packet 225, said sound signal being broadcast when the period number of the beacon frame signal 230 received independently of the data packets 225 represents a number greater than or equal to the period number calculated. This constant value corresponds to an arbitrary value selected to represent the maximum transmission time between a sound transmitter and the broadcaster that is the farthest away.

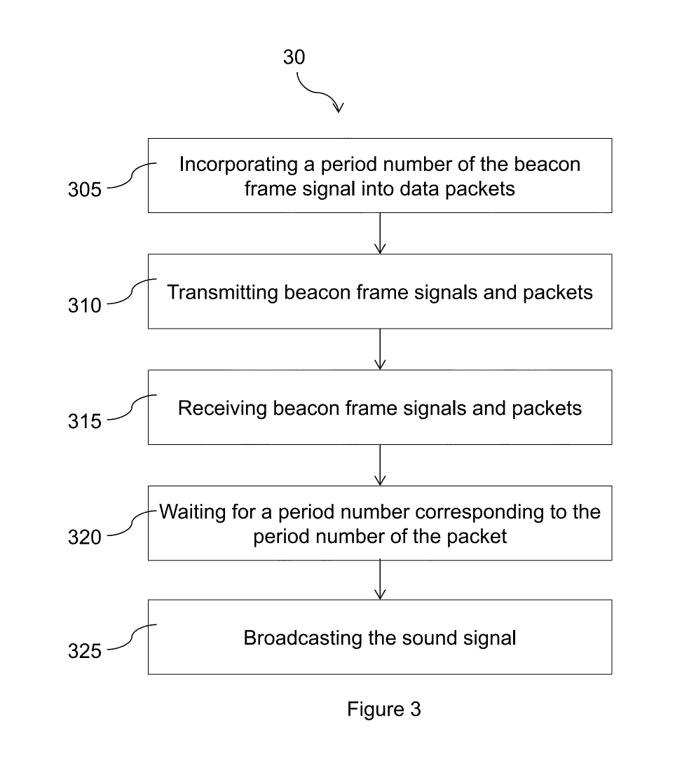

FIG. 3 shows a logical diagram of particular steps of the method 30 for synchronizing the broadcasting of sound signals that is the subject of the present invention. This method comprises:
a step 305 of incorporating a period number of the beacon frame signal into data packets representative of the sound signal to be broadcast by at least one sound-signal broadcaster; and
a step 310 of transmitting signals according to standard IEEE 802.11 representing:
   the beacon frame signal and
   the packets representative of sound signals to be broadcast,
a step 315 of receiving beacon frame signals and packets;
a step 320 of waiting for a period number of the beacon frame signal;
a step 325 of broadcasting the sound signal.

The step 305 of incorporating a period number of the beacon frame signal can be carried out, for example, by reading the current 802.11 TSF period number in the beacon frame signal and incorporating this number into the metadata of the packet containing the data representative of a sound signal to be broadcast. This number can, for example, be incorporated into a metadata called “time to play”.

The step 310 of transmitting signals can be carried out by a Wi-Fi antenna, the packets being intended for wireless sound-signal broadcasters. This antenna transmits both the beacon signal and each packet containing data representative of the sound signal in the desired order for reading these representative data.

The step 315 of receiving beacon frame signals and packets can be carried out by an antenna of each sound signal broadcaster, for example.

The step 320 of waiting for a period number of the beacon frame signal corresponding to the period number of the beacon frame signal incorporated in the packet can be carried out, for example, by each sound signal broadcaster. These sound signal broadcasters iteratively compare the period number of the beacon frame signal, incorporated into each packet received and put on hold, with the period number of the beacon frame signal received. When the incorporated and received period numbers of the beacon frame signal match, the broadcasting step 325 takes place.

The step 325 of broadcasting the sound signal represented by each data packet can be carried out by each sound-signal broadcaster at a predefined time on the basis of the period number incorporated into said packet. In certain embodiments, this broadcast time can be determined during the incorporation step 305 by adding a constant value to the beacon frame period number read before incorporating it into the packet. In other embodiments, this broadcast time can be calculated during the broadcasting step 325 by adding a constant value to the beacon frame period number read in the metadata of the packet.

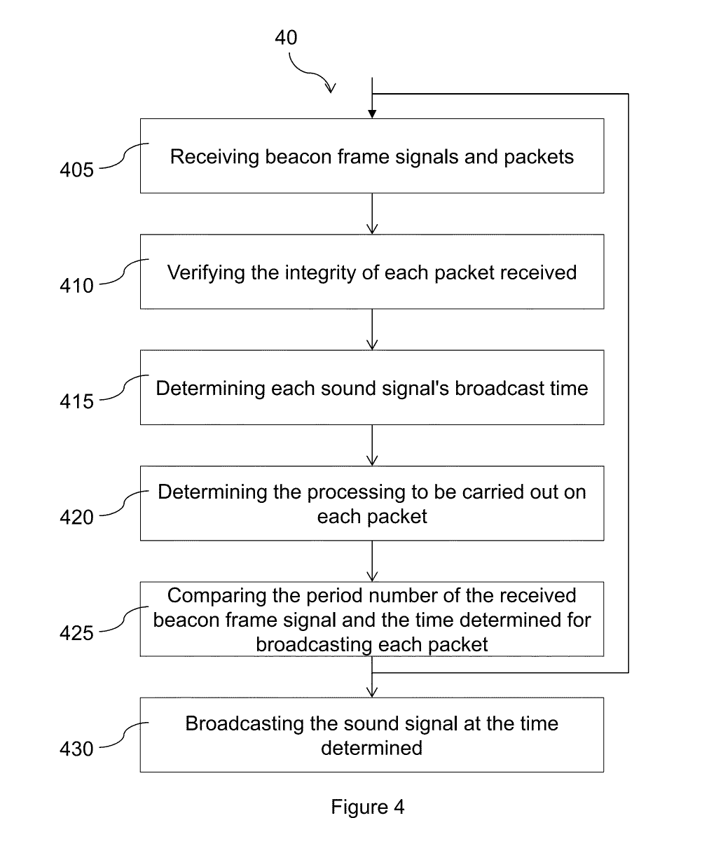

FIG. 4 shows a logical diagram of particular steps of the method 40 for broadcasting of sound signals that is the subject of the present invention. The method 40 comprises:
a step 405 of receiving signals according to standard IEEE 802.11;
a step 410 of verifying the integrity of each packet received;
a step 415 of determining the time of the sound signal's broadcast by each sound-signal broadcaster;
a step 420 of determining a processing operation to be carried out on each received packet;
an iterative step 425 of comparing the period number of the received beacon frame signal and the period number of the beacon frame signal incorporated into the received packet; and
a step 430 of broadcasting the sound signal.

The step 405 of receiving signals can be carried out by a Wi-Fi antenna, for example. The signals received correspond to a beacon frame signal, a set of packets containing data representative of a sound signal. A “time to play” metadata element is incorporated in each packet, representative of the period number of the beacon frame signal on which the data contained in the packet is to be broadcast.

The step 410 of verifying the integrity of each packet received can be carried out by using an imprint, such as a checksum, for example. If the integrity of the packet cannot be verified, this is reconstituted if the checksum permits it, otherwise the packet is ignored.

The step 415 of determining the time of the sound signal's broadcast by sound-signal broadcasters, adds a constant value to a period number of the beacon frame signal read in each packet received. This constant value corresponds to the maximum propagation time between the transmitter of the received packet and each broadcaster having to carry out step 430 of broadcasting the sound signal.

The step 420 of determining a processing operation to be carried out on each received packet calculates the difference between the period number of the received beacon frame signal and the period number of the beacon frame signal incorporated into the received packet. In this way, for example, if a packet is received with a delay greater than a predefined limit value with respect to its broadcast time, it is ignored by the broadcaster. If its broadcast time has not yet arrived, it is put on hold. If it is in the interval, the data representative of the sound signal are broadcast immediately. The predefined limit value can correspond, for example, to the length of time to read the data representative of the sound signal contained in a packet, for example.

The iterative step 425 of comparing the period number of the received beacon frame signal and the period number of the beacon frame signal incorporated into the received packet can be carried out by an electronic circuit comprising a computer program able to extract the period number of the beacon frame signal incorporated in the packer received and the period number of the beacon frame signal received, and to compare the two values.

The step 430 of broadcasting the sound signal represented by each data packet received on the basis of the result of the comparison step is carried out when the period number of the beacon frame signal incorporated in the packet received and the period number of the beacon frame signal received match.

In this way, as can be seen by reading the description above, the invention consists in particular of turning the beacon frame signal from its initial purpose to make it a synchronization element between different appliances in a wireless network, making it possible to determine a sound-signal's broadcast time. The present invention makes it possible to carry out the synchronization between a transmitter and broadcasters of sound signals without the need to generate a clock independent of the communication system used (here, the standard IEEE 802.11). The present invention uses the beacon frame signal, which carries out the synchronization from the network point of view between transmitters and receivers of Wi-Fi signals, so as to synchronize the broadcasting of sound signals. To do this, a metadata element corresponding to a beacon frame period number is incorporated into each packet. When this period number arrives, the data contained in this packet are broadcast. In the description of FIG. 1, it can be seen in particular that a time offset can be added to the period number of the beacon frame signal read by the incorporation means in order to give a safety period to the device's set in case of communication difficulties. In the description of FIG. 2, it can be seen in particular that this offset can be calculated by the broadcaster. It can be seen, in the description of FIGS. 3 and 4, the operation of the methods that detail the operation of the means described in FIGS. 1 and 2.

### EXAMPLE OF APPLICATION

In an example of application, one considers a wireless network utilizing the DLNA operability standard, comprising:
a “Digital Media Server” (“DMS”) configured to make digital content available to other appliances in the network;
a “Digital Media Controller” (“DMC”) configured to browse through the content available on the DMS; and
two “Digital Media Renderers” (“DMR”), here called DMR1 and DMR2, configured to decode and play digital content sent by a DMC. In addition, DMR1 is configured to stream digital content received from a DMS.

For example, a portable communicating terminal can comprise the DMS and DMC in the form of a hard disk type of memory (DMS) and an operating system (DMC) configured to make it possible to select digital content present on the hard disk. Alternatively, the DMS can be a remote memory to which the portable communicating terminal (DMC) connects. The DMRs can be sound broadcasters connected to the DMC.

When a user wants to play a digital content, the DMC connects to the DMS and to DMR1, which controls DMR2. Thus, indirectly, the DMC controls all the DMRs. Then, the DMC is utilized and the user selects a content from amongst a list of contents proposed by the DMS. The DMC sends a command to DMR1 telling it to connect to a resource (the digital content to be played) of the DMS identified by a URI (“unified resource identifier”). In response, the DMR1 supplies this URI to the portion of the DMRI responsible for streaming, and supplies the portions of the DMR1 and DMR2 responsible for playing media with the URI of the portion of the DMR1 responsible for streaming. When the user decides to play the digital content, the DMC sends a read command to the DMR1. Then, the portion of the DMR1 responsible for streaming decodes the content read in the DMS and transfers this content via an RTP (“real-time transfer protocol”) connection transported by a UDP (“user datagram protocol”) protocol. The system generated in this way is managed by the RTSP (“real time streaming protocol”) protocol.

In variants, the portion of the DMR1 responsible for streaming decodes the content read in the DMS and transfers this content via an RTP (“real-time transfer protocol”) connection transported by a TCP (“transmission control protocol”) protocol. The system generated in this way is managed by the HTTP (“hypertext transfer protocol”) protocol.

Lastly, in a synchronized way, the DMRs play the digital content selected by the user. The synchronized being achieved by the creation of a “time to play” metadata by the portion of the DMR1 responsible for streaming using the beacon frame signal as described above.

1-14. (canceled)

15. Device for synchronizing the broadcasting of sound signals, utilizing the IEEE 802.11 standard comprising the transmission of a periodic IEEE 802.11 beacon frame signal separate from the transmitted data and representative of the period number of the beacon frame signal, comprising:
a controller configured for incorporating a period number of the beacon frame signal into data packets representative of the sound signal to be broadcast by at least one sound-signal broadcaster; and
a transmitter for transmitting signals according to standard IEEE 802.11 representing:
the beacon frame signal and
the packets representative of sound signals to be broadcast, in such a way that each sound-signal broadcaster can broadcast the sound signal represented by each data packet at a predefined time on the basis of the period number incorporated into said packet.

16. Device according to claim 15, wherein the controller is configured to incorporate period number of the beacon frame signal into each data packet representative of the sound signal.

17. Device according to claim 15, wherein the transmitter is configured to determine the instant of the sound signal's broadcast by each sound-signal broadcaster, adding a constant value to the current period number of the beacon frame signal.

18. Device according to claim 15, wherein the transmitter is configured to utilize an RTP connection transported by the UDP protocol, the session thus generated being managed by the RTSP protocol.

19. Device according to claim 15, wherein the transmitter is configured to utilize an RTP connection transported by the TCP protocol, the session thus generated being managed by the HTTP protocol.

20. Sound-signal broadcaster utilizing the IEEE 802.11 standard comprising the transmission of a periodic IEEE 802.11 beacon frame signal separate from the transmitted data and representative of the period number of the beacon frame signal, comprising a receiver for receiving signals according to standard IEEE 802.11 representing:
the beacon frame signal and
at least one packet representative of the sound signals to be broadcast into which a period number of the beacon frame signal has been incorporated,
in such a way as to broadcast the sound signal represented by each data packet at a predefined time on the basis of the period number incorporated into said packet.

21. Broadcaster according to claim 20, further comprising a controller for determining a processing operation to be carried out on each received packet on the basis of the difference between the period number of the received beacon frame signal and the period number of the beacon frame signal incorporated into the received packet.

22. Broadcaster according to claim 20, further comprising a calculator for calculating the broadcast instant of the sound signal represented by data in a packet, which adds a constant value to the period number of the beacon frame signal associated to said packet, said sound signal being broadcast when the period number of the beacon frame signal received independently of the data packets represents a number greater than or equal to the period number calculated.

23. Broadcaster according to claim 20, wherein the receiver is configured to utilize an RTP connection transported by the UDP protocol, the session thus generated being managed by the RTSP protocol.

24. Broadcaster according to claim 20, wherein the receiver is configured to utilize an RTP connection transported by the TCP protocol, the session thus generated being managed by the HTTP protocol.

25. Method for synchronizing the broadcasting of sound signals, utilizing the IEEE 802.11 standard comprising the transmission of a periodic IEEE 802.11 beacon frame signal separate from the transmitted data and representative of the period number of the beacon frame signal, comprising:
incorporating a period number of the beacon frame signal into data packets representative of the sound signal to be broadcast by at least one sound-signal broadcaster; and
transmitting signals according to standard IEEE 802.11 representing:
the beacon frame signal and
the packets representative of sound signals to be broadcast; and
broadcasting the sound signal, represented by each data packet, by each sound-signal broadcaster at a predefined time on the basis of the period number incorporated into said packet.

26. Method for broadcasting sound signals utilizing the IEEE 802.11 standard comprising the transmission of a periodic IEEE 802.11 beacon frame signal separate from the transmitted data and representative of the period number of the beacon frame signal, comprising:
receiving signals according to standard IEEE 802.11 representing:
the beacon frame signal and
at least one packet representative of the sound signals to be broadcast into which a period number of the beacon frame signal has been incorporated,
verifying the integrity of each packet received;
iteratively comparing the period number of the received beacon frame signal and the period number of the beacon frame signal incorporated into the received packet; and
broadcasting the sound signal represented by each data packet received on the basis of the result of the comparison step.

27. Method according to claim 26, further comprising determining the instant of the sound signal's broadcast by sound-signal broadcasters, adding a constant value to a period number of the beacon frame signal read in each packet received.

28. Method according to claim 26, further comprising determining a processing operation to be carried out on each received packet on the basis of the difference between the period number of the received beacon frame signal and the period number of the beacon frame signal incorporated into the received packet.
